(19) United States
(12) Patent Application Publication
(10) Pub. No.: US 2005/0190759 A1
(43) Pub. Date: Sep. 1, 2005

(54) Method for transmitting a hello packet and a medium access control protocol layer module of a mobile station in a mobile ad hoc network

(75) Inventors: Jai-Ho Lee, Suwon-si (KR); Joong-Soo Ma, Yuseong-gu (KR); Myung-Hwan Seo, Yuseong-gu (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/958,799

(22) Filed: Oct. 5, 2004

(30) Foreign Application Priority Data
Feb. 28, 2004 (KR) 2004-0013763

(51) Int. Cl. H04L 12/56

(52) U.S. Cl. 370/389

(57) ABSTRACT

A method for transmitting a hello packet from a plurality of nodes in a mobile ad hoc network (MANET). The nodes have a predetermined identical counter value. The nodes to simultaneously wake up during a predetermined beacon interval (BI) according to the predetermined counter value, and maintain an awake state in order to transmit/receive the hello packet.

### PRIORITY

This application claims priority to an application entitled “Method for Transferring Hello Packet and Medium Access Control Protocol Layer Module of Mobile Station in Mobile Ad Hoc Network” filed in the Korean Intellectual Property Office on Feb. 28, 2004 and assigned Ser. No. 2004-0013763, the contents of which are hereby incorporated by reference.

### BACKGROUND OF THE INVENTION

1. Field of the Invention

The present invention relates generally to a mobile ad hoc network (MANET) for constructing a network by using a plurality of mobile stations (hereinafter, referred to as “stations”), and more particularly to a method for transferring hello packets and a medium access control (MAC) protocol layer module for wireless local area networks (LANs) according to an IEEE 802.11 standard.

2. Description of the Related Art

A MANET is an infrastructureless network that has no fixed routers, hosts, or wireless base stations. In the MANET, mobile stations are connected to each other using a multi-hoping technique on a peer-to-peer level. Therefore, the MANET can dynamically change a network topology and perform “self-forming” and “self-healing”.

In the MANET, a node by itself can construct infrastructures for a network routing in an ad hoc form, because more than a stationary base station can provide mobile services. Also, each node included in the MANET can freely move without restrictions, thereby enabling a proper protocol for network topology changes according to swift movement of the nodes.

In order to construct the MANET, nodes must have information about neighboring nodes and routing information for reaching destination nodes to which data will be transferred. The above-described functions are achieved through routing protocols. Currently, one of the most widely used routing protocols in the MANET is an ad hoc on demand distance vector (AODV).

The AODV determines a route through a method in which, on the assumption that a predetermined node has data to be transferred and that a routing table of the predetermined node has no routing information about a destination node, if the predetermined node broadcasts a route request “RREQ” through a hop-by-hop method, such that the RREQ reaches the destination node, the destination node sends a route reply “RREP” to a source node through a unicast method in reverse. In the MANET, because routing information frequently changes due to the free movement of nodes and phenomena such as fading and interference between wireless links, the AODV enables the predetermined node to maintain recent information about neighboring nodes, i.e., nodes that are adjacent to the predetermined node, using a hello packet.

FIGS. 1A and 1B illustrate AODV routing in the MANET. Referring to FIGS. 1A and 1B, because each of nodes N110 to N8 80 can communicate with each other within restricted regions, each of nodes N1 10 to N8 80 can directly communicate with only neighboring nodes. Also, each of nodes N1 10 to N8 80 maintains a track between neighboring nodes by receiving a hello packet broadcasted from the nodes during set intervals.

More specifically, a predetermined node periodically broadcasts a hello packet to neighboring nodes for every hello interval, which is default 1 sec, in order to report existence of the predetermined node to the neighboring nodes. When a predetermined node receives the hello packet from neighboring nodes, the predetermined node updates information related to a node that has transmitted a hello message, i.e., an item of a lifetime in a routing table. If a corresponding entry does not exist, the corresponding entry is newly created and inserted into the routing table. If the hello packet is not received from a corresponding node during the lifetime, it is concluded that it is impossible to make communication with the corresponding node and an entry of the corresponding node is removed from the routing table.

Referring to FIGS. 1A and 1B, when a predetermine node, for example, the node N1 10 transfers a message to another node, which is not a neighboring node, for example, the node N8 80, the node N1 10 broadcasts an RREQ message. The RREQ message includes information about several items such as a source, a destination, a life span of a message, and a sequence number used as a dedicated identification (ID). Neighboring nodes N2 20, N3 30, and N4 40 receive the RREQ packet, and broadcast the RREQ message to their neighboring nodes. If the RREQ packet has been transferred to the destination node N8 80 from the source node N1 10 through the method described above, the destination node N8 80 transfers an RREP packet to the source node N1 10 in a unicast method as illustrated in FIG. 1B.

An IEEE 802.11 Wireless LAN Standard has designated a distributed coordination function (DCF) as a medium access control (MAC) protocol for supporting the MANET and has suggested a power saving mode (PSM) in order to save power. Nodes having a DCF-PSM mode are in either an awake state or a doze state. Nodes in the awake state can receive or transmit a frame and consume energy of an amount varying depending on operation states of the nodes. In contrast, nodes in the doze state cannot perform communication, but consume the less energy.

All nodes in the doze state periodically wake up, and then, the nodes are in the awake state during a predetermined period of time every beacon interval (BI). If the nodes have data such as routing protocol packets (e.g., the RREQ packet, the RREP packet, or the hello packet), or user application packets, which will be transferred, the nodes transfer an announcement traffic indication message (ATIM), such that reception nodes, which will receive a corresponding packet, wake up during the BI. Thereafter, the nodes transfer the corresponding packet to the reception nodes.

While performing the PSM, each node reduces power supply if each node does not transmit or receive packets. Also, each node wakes up at a predetermined period of time, which is a beacon interval, in order to communicate with other nodes by reporting if the node transfers packets or determining if the node receives packets by means of the ATIM, thereby reducing power consumption.

FIG. 2 illustrates the PSM in the MANET. Referring to FIG. 2, a node A 110 transfers the ATIM to the node B 120 during an ATIM window interval, thereby notifying a node B 120 of whether or not there are packets to be transferred. After the node B 120 receives the ATIM from the node A 110 during the ATIM window interval, the node B transfers an ACK message corresponding to the ATIM to the node A 100. The node A 110 transfers the packets to the node B 120. If the node B 120 receives the packets, the node B 120 transfers an ACM message corresponding to the packets to the node A 110.

As described above, if the AODV and the DCF-PSM of the IEEE 802.11 MAC are used in the MANET, there are a number of limits and problems in view of power consumption. For example, when there are no upper class application packets to be transferred by a predetermined node and the number of nodes used in the MANET linearly increases, the period of time during which neighboring nodes must wake up in order to exchange a hello packet with each other exponentially increases. Therefore, battery power rapidly decreases due to a routing protocol process of searching for neighboring nodes even if no user packets are exchanged between nodes in a power turn-on state of a predetermined node.

The worst case is when hello intervals (His) for hello messages to be transferred by nodes used in the MANET are distributed independently from BIs. At this time, if the number of neighboring nodes adjacent to a predetermined node is greater than “(hello interval/beacon interval)-1”, all nodes are always in the awake state, such that the PSM is ineffective.

For example, if the HIs are independent from BIs, in an operation related to the PSM in a waiting mode, in which users packets are not exchanged between nodes, a default value of the HI suggested through the AODV is about 1 sec. Also, a default value of the BI suggested in the IEEE 802.11 is about 100 msec. If the number of nodes used in the MANET is equal to ‘1’, the MANET has one awake state and nine doze states during the HI. If the number of the nodes is equal to ‘2’, the MANET has four awake states and 16 doze states during the HI. If the number of the nodes is equal to ‘9’, the MANET has 81 awake states and nine doze states during the HI. If the number of the nodes is equal to ‘10’, the MANET has 100 awake states and no doze state. That is, assuming that default values of the HI and the BI are used, if at least ten nodes exist in the MANET, all nodes are regarded as nodes that are always awake, such that the nodes do not use a PSM.

### SUMMARY OF THE INVENTION

Accordingly, the present invention has been designed to solve the above and other problems occurring in the prior art, and an object of the present invention is to provide a method for transferring a hello packet and a medium access control protocol layer module, which enable power saving even if the number of nodes increases, when utilizing an AODV and an IEEE 802.11 DCF-PSM, and constructing a multi-hop ad hoc network.

In order to accomplish the above and other objects, there is provided a method for transferring a hello packet and a medium access control protocol layer module, enabling all nodes included in a MANET to wake up simultaneously at a same BI every HI. The nodes exchange only a hello packet and not an ATIM frame because the nodes have been already awaken during the BI. The nodes maintain a doze state in order to minimize power consumption, if the nodes have no packets to be transmitted or received during remaining BI.

### BRIEF DESCRIPTION OF THE DRAWINGS

The above and other objects, features, and advantages of the present invention will be more apparent from the following detailed description taken in conjunction with the accompanying drawings, in which:

FIGS. 1A and 1B illustrate an AODV routing in a MANET;

FIG. 2 illustrates a PSM in a MANET;

FIG. 3 illustrates a structure of a MAC protocol layer module of a mobile station in a MANET according to an embodiment of the present invention;

FIG. 4 illustrates a structure of a beacon frame in a MANET according to an embodiment of the present invention;

FIG. 5 is illustrates a control flow for finding a BI for wake up of each node according to an embodiment of the present invention;

FIG. 6 illustrates a control flow for representing an operation of each node according to an embodiment of the present invention; and

FIG. 7 illustrates transmission/reception of hello packets by a plurality of nodes awaken at the same BI according to the present invention.

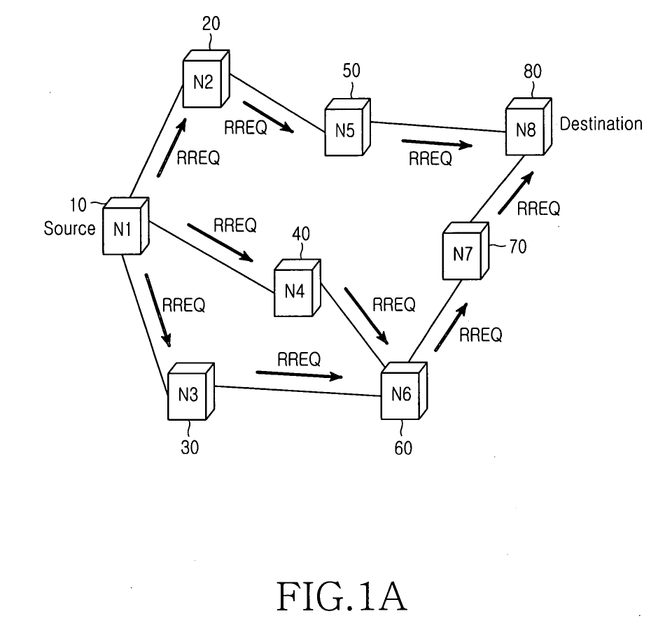

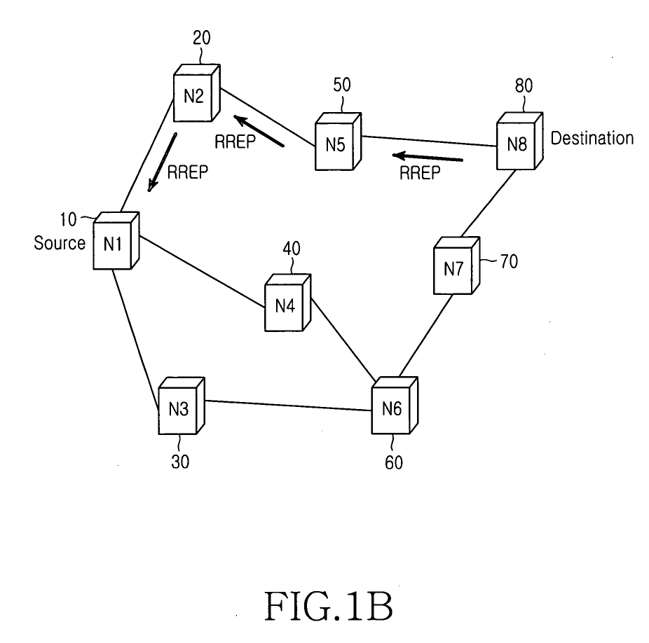

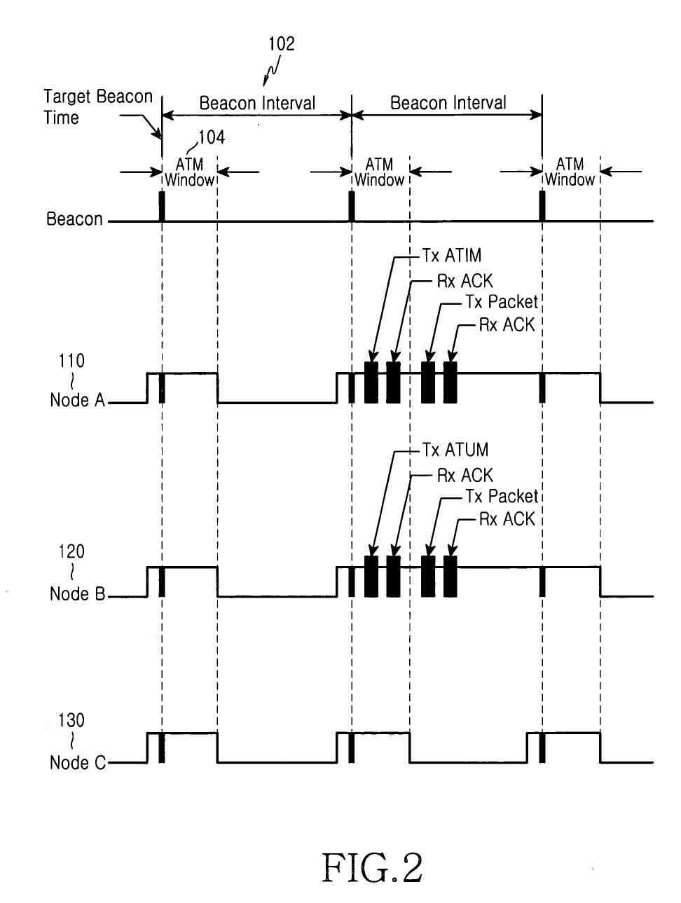

### DETAILED DESCRIPTION OF THE PREFERRED EMBODIMENTS

Preferred embodiments of the present invention will be described in detail herein below with reference to the accompanying drawings. The same or similar components in drawings are designated by the same reference numerals as far as possible although they are shown in different drawings. Additionally, in the following description of the present invention, a detailed description of known functions and configurations incorporated herein will be omitted when it may obscure the subject matter of the present invention.

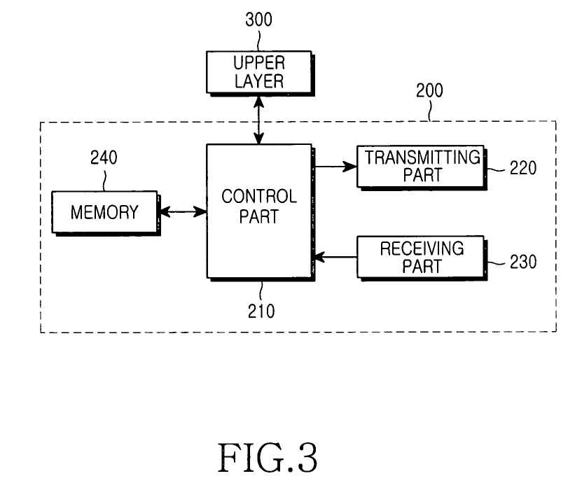

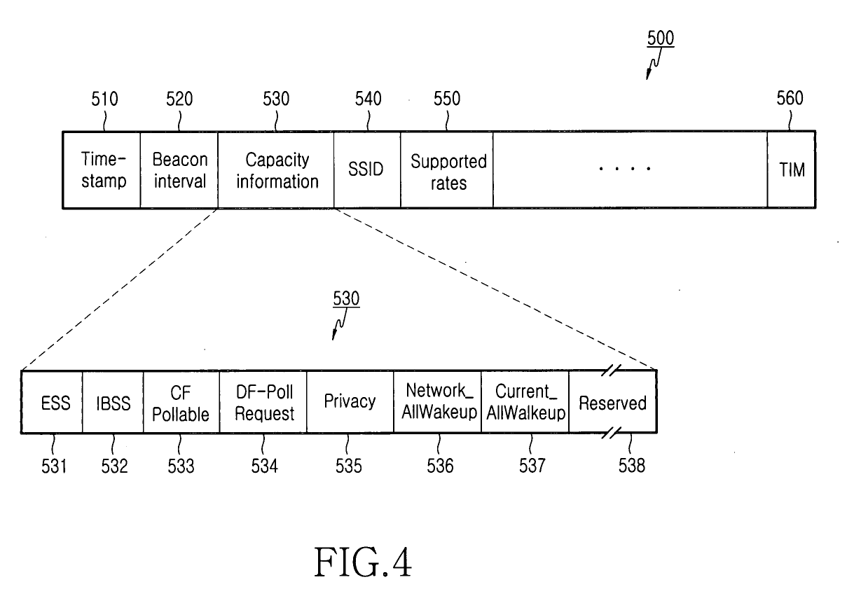

FIG. 3 illustrates a MAC protocol layer module 200 of a mobile station in a MANET according to an embodiment of the present invention, and FIG. 4 illustrates the beacon frame format in an MANET according to an embodiment of the present invention. Referring to FIG. 3, according to the present invention, the MAC protocol layer module 200 of the mobile station includes a control part 210, a transmitting part 220, a receiving part 230, and a memory 240. When the mobile station having the MAC protocol layer module 200 constructs the MANET, the control part 210 transfers a beacon frame 500, as illustrated in FIG. 4, to another node.

Referring to FIG. 4, the beacon frame 500 includes a time-stamp field 510, a beacon interval field 520, a capacity information field 530, a service set identifier (SSID) field 540, a supported rates field 550, . . . , a traffic indicating map (TIM) field 560, etc. According to the present invention, the capacity information field 530 includes an extended service set (ESS) field 531, an independent basic service set (IBSS) field 532, a contention-free (CF) pollable field 533, a directory facilitator (DF)-poll request field 534, and a privacy field 535. In addition, the capacity information field 530 further includes a network_allwakeup field 536 and a current_allwakeup field 537. The network_allwakeup field 536 and the current_allwakeup field 537 can be embodied in a reserved field 538 allotted in the typical capacity information field 530. The network_allwakeup field 536 and the current_allwakeup field 537 define counters. A value of the network_allwakeup field 536 represents a predetermined period of time for creating a hello interval (HI) and is set as a multiple of a beacon interval (BI). A value of the current_allwakeup field 537 represents the turn of a current BI during the HI and is changed whenever the beacon frame is received.

At the initial construction of the MANET, the control part 210 of an initial node selects a predetermined initial value and inserts the predetermined initial value into the network_allwakeup field 536 and the current_allwakeup field 537 in order to transfer the beacon frame. Also, when a node is newly joined in the already-constructed MANET, the control part 210 of the node stores the values of the network_allwakeup field 56 and the current_allwakeup field 537 included in the received beacon frame in the memory 240. The value of the network_allwakeup field 536 is stored in the memory 240 as “mynetwork”, and the value of the current_allwakeup field 537 is stored in the memory 240 as “mycurrent”.

When transferring the beacon frame 500 to another node, if a value of the current_allwakeup field 537 stored in the memory 240, which is a value of the mycurrent, is greater than ‘0’, the control part 210 inserts a value of the mycurrent into the current_allwakeup field 537 of the beacon frame 500, after subtracting ‘1’ from a value of the mycurrent. In addition, if a value of the mycurrent stored in the memory 240 is equal to ‘0’, a value of the current_allwakeup field 537 of the beacon frame 500 is initialized as a value of the network_allwakeup stored in the memory 240, which is a value of the mynetwork, and then transferred.

If a value of the current_allwakeup field 537 of the received beacon frame 500 is equal to ‘0’, the control part 210 maintains an awake state during a corresponding BI in order to exchange a hello packet. Also, the control part 210 selects the awake state or a doze state according to a state of existence of packets to be received or transmitted.

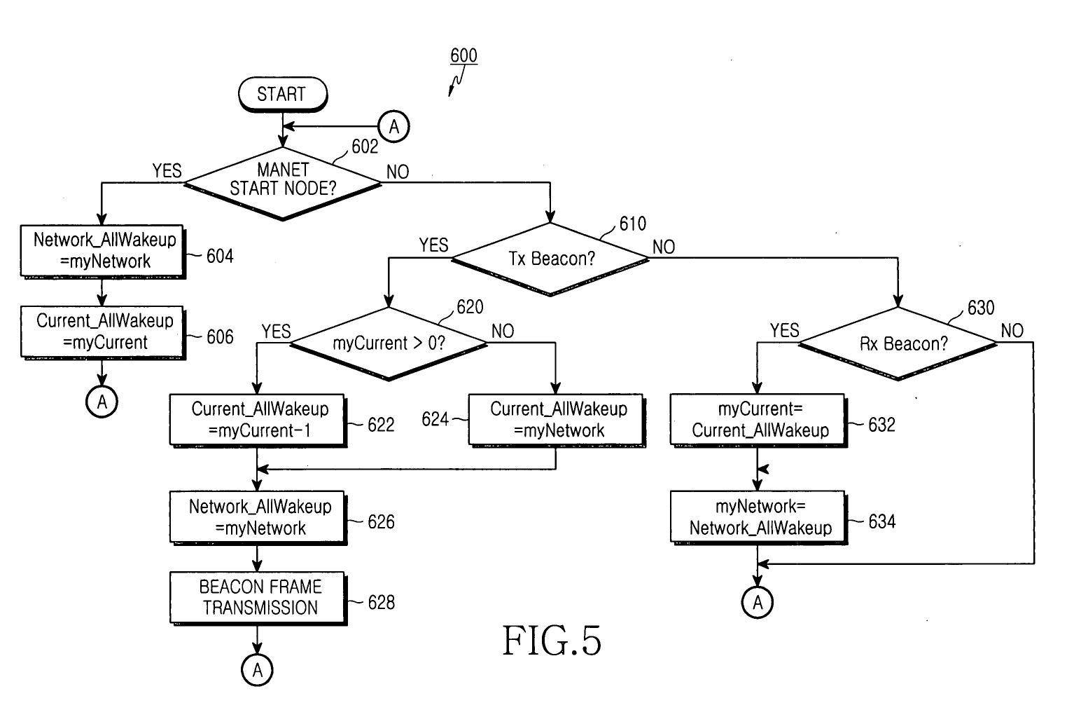

FIG. 5 illustrates a control flow for determining a BI for wake up of each node according to one embodiment of the present invention. Referring to FIG. 5, first, the control part 210 determines if the control part 210 is a start node of the MANET in step 602. If a node_initially constructs the MANET, the node must transfer a beacon frame to another node. If the control part 210 is the start node of the MANET, the control part performs step 604. If the control part 210 is a node initially constructing the MANET in step 604, the control part 210 selects a predetermined initial value and inserts the predetermined initial value into the network_allwakeup field 536 and the current_allwakeup field 537 in order to transfer the beacon frame. The control part 210 stores a value of the network_allwakeup field 536 in the memory 240 in step 604, and stores a value of the current_allwakeup field 537 in the memory 240 in step 606.

However, if the control part 210 is not the start node of the MANET, the control part 210 determines if the control part 210 transfers a beacon frame in step 610. If the control part 210 transfers the beacon frame, in step 620, the control part 210 determines if a value of the current_allwakeup field 537 stored in the memory 240, which is a value of the mycurrent, is greater than ‘0’. If the value of the mycurrent stored in the memory 240 is greater than ‘0’, in step 622, the control part 210 subtracts ‘1’ from the value of the mycurrent and inserts the value of the mycurrent as a value of the current_allwakeup field 537 of the beacon frame.

If the value of the mycurrent stored in the memory 240 is less than or equal to ‘0’ in step 620, the control part 210 initializes the current_allwakeup field 537 of the beacon frame as the value of the mynetwork stored in the memory 240 in step 624.

Subsequently, the control part 210 stores the value of the network_allwakeup field 536 of the beacon frame to be transferred in the memory 240 as the value of the mynetwork in step 626. After that, the control part 210 transfers the beacon frame in step 628.

If the control part 210 determines not to transfer a beacon frame, the control part 210 determines if the beacon frame is received in step 630. If the beacon frame is received, the control part 210 stores a value of the current_allwakeup field 537 of the received beacon frame in the memory 240 as a value of the mycurrent in step 632. Further, the control part 210 stores a value of the network_allwakeup field 536 of the received beacon frame in the memory 240 as a value of the mynetwork in step 634.

Accordingly, if the value of the current_allwakeup field of the received beacon frame 500 is equal to ‘0’, the control part 210 maintains an awake state during a corresponding BI in order to exchange a hello packet.

As described above, each node can maintain two identical counters by using the network_allwakeup field 536 and the current_allwakeup field 537 of the beacon frame. Therefore, each node can be established in such a manner that each node can wake up at the same BI according to the two counters.

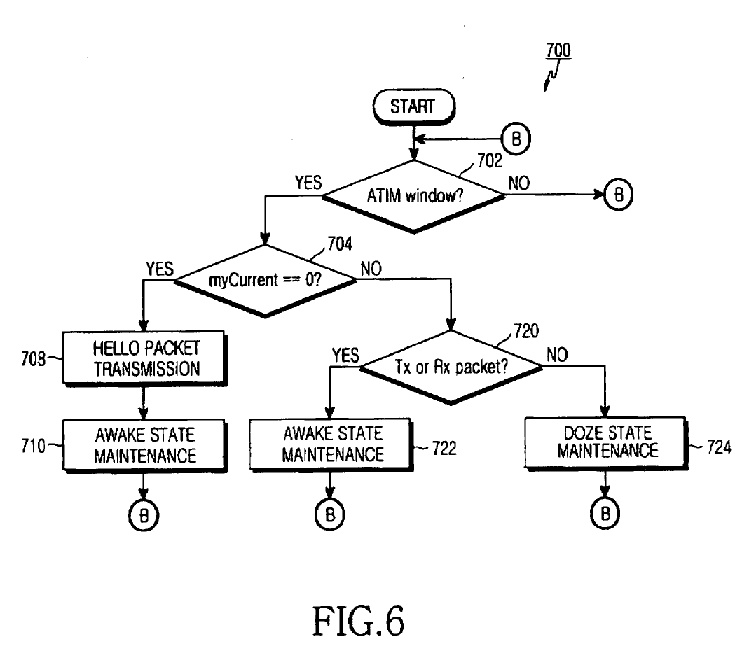

FIG. 6 illustrates a control flow representing the operation of each node according to an embodiment of the present invention. Referring to FIG. 6, the control part 210 determines if an ad hoc traffic indication message (ATIM) window occurs in step 702. If the ATIM window occurs, the control part 210 determines if a value of the mycurrent stored in the memory 240 is equal to ‘0’ in step 704. As described above, each node can maintain two identical counters by using the network_allwakeup field 536 and the current_allwakeup field 537 of the beacon frame 500. Herein, a value of the network_allwakeup field 536 represents a period for generating a hello interval (HI) and is equal to a multiple of a beacon interval (BI). A value of the current_allwakeup field 537 represents the turn of a current BI during the HI. The values of the network_allwakeup field 536 and the current_allwakeup field 537 of the beacon frame 500 are stored as the mynetwork and the mycurrent, respectively, in each node. The mycurrent is changed according to a lapse of the BI, that is, transmission/reception of the beacon frame, so that each node has the same counter value.

If a value of the mycurrent is equal to ‘0’, all nodes are set to wake up. Accordingly, in the control flow illustrated in FIG. 6, if the value of the mycurrent is equal to ‘0’, the control part 210 transmit a hello packet in step 708, and then, maintains an awake state in step 710, thereby receiving hello packets from other nodes.

However, if the value of the mycurrent is not equal to ‘0’, the control part 210 determines if packets are received from neighboring nodes or packets are transmitted to neighboring nodes. If the packets must be transmitted/received for neighboring nodes, the control part 210 maintains the awake state in step 722. However, if there are no operations of transmitting/receiving the packets for neighboring nodes, the control part 210 maintains the doze state in step 724.

As described above, according to the present invention, nodes wake up at the same BI and can transmit/receive hello packets

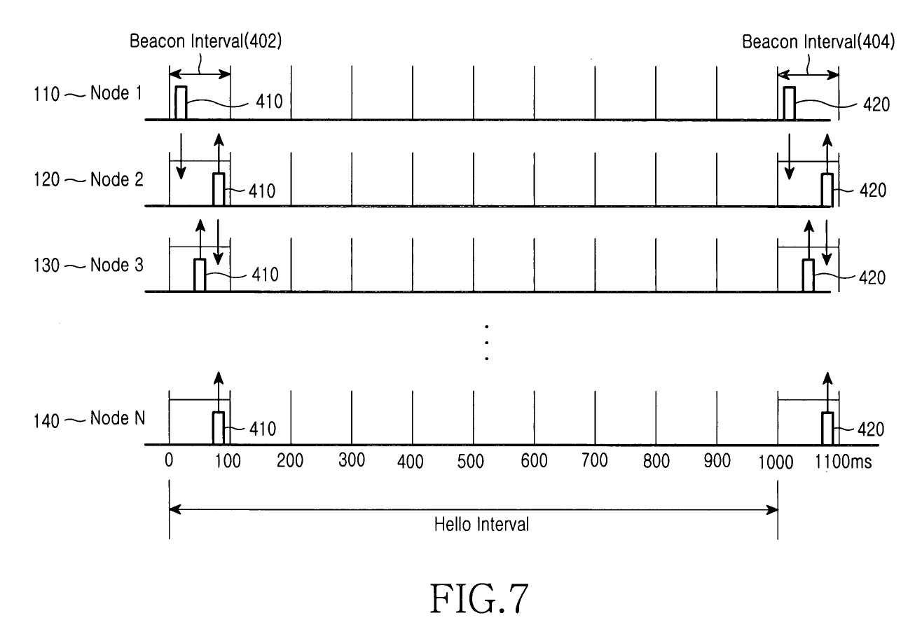

FIG. 7 illustrates transmission/reception of hello packets 410 and 420 by a plurality of nodes 110 to 140, which are awaken at the same BI, according to the present invention. As described above, the nodes 110 to 140 know a hello interval (HI), which is a multiple of a beacon interval (BI) 402, and the BI 402 for transmitting a hello packet. The nodes 110 to 140 wake up at the same BIs 402 and 404 and can transmit/receive the hello packets 410 and 420 as illustrated in FIG. 7.

As describe above, according to the present invention, in order to transfer hello packets of the AODV, a BI is periodically assigned as a predetermined period of time for delivering the hello packets in such a manner that the hello packets minimize influence on the DCF-PSM in view of power. Accordingly, it is possible to prevent decreases in performance of applications and protocols, and to save as much energy as possible. In particular, when utilizing a suggested method, it is possible to considerably reduce loss of energy caused without exchanging users application packets in a waiting mode.

While the present invention has been shown and described with reference to certain preferred embodiments thereof, it will be understood by those skilled in the art that various changes in form and details may be made therein without departing from the spirit and scope of the invention. Consequently, the scope of the invention should not be limited to the above embodiments, but should be defined by the appended claims and equivalents thereof.

1. A method of transmitting a hello packet from a plurality of nodes in a mobile ad hoc network (MANET), the method comprising the steps of:
assigning the nodes to have an identical predetermined counter value; and
simultaneously waking up the nodes during a predetermined beacon interval (BI) according to the predetermined counter value in order to maintain an awake state, and to transmit and receive the hello packet.

2. The method as claimed in claim 1, further comprising a step of assigning the nodes to have an identical hello interval (HI) value, which is a period for transferring the hello packet.

3. The method as claimed in claim 2, wherein the predetermined counter value and the value of the hello interval are transferred to the nodes by using a reserved field of a beacon frame.

4. The method as claimed in claim 1, wherein the predetermined counter value is a beacon interval counter value that changes according to transmission and reception of a beacon frame.

5. The method as claimed in claim 4, wherein each of the nodes renews its own beacon interval counter value to a beacon interval counter value of the beacon frame, when each of the nodes receives the beacon frame.

6. The method as claimed in claim 4, wherein each of the nodes changes its own beacon interval (BI) counter value and inserts a changed beacon interval (BI) counter value of said each node into a reserved field of the beacon frame to be transferred, when each node transmits the beacon frame.

7. A method of transmitting a hello packet in a mobile ad hoc network (MANET) by a medium access control protocol layer module, the method comprising the steps of:
changing a predetermined counter value upon one of a beacon frame transmission and a beacon frame reception;
maintaining an awake state after waking up during a predetermined beacon interval (BI) according to the predetermined counter value; and
performing one of transmitting and receiving the hello packet.

8. The method as claimed in claim 7, wherein the predetermined counter value is a beacon interval (BI) counter value that changes according to one of the transmission and the reception of the beacon frame.

9. The method as claimed in claim 8, wherein, when the beacon frame is transmitted, the beacon interval counter value of each of a plurality of nodes is changed and a changed beacon interval (BI) counter value is inserted in a reserved field of the beacon frame to be transferred, and when the beacon frame is received, the beacon interval counter value of each of the plurality of nodes is renewed to the beacon interval counter value of the beacon frame.
